(19) United States
(12) Patent Application Publication
(10) Pub. No.: US 2008/0026887 A9
(43) Pub. Date: Jan. 31, 2008

(54) Hydraulic control system of continuously variable transmission for vehicle

(76) Inventor: Hyun Suk Kim, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/590,988

(22) Filed: Nov. 1, 2006

(30) Foreign Application Priority Data
Dec. 10, 2005 (KR) 10-2005-0121385

(51) Int. Cl. F16H 61/00; F16H 59/00

(52) U.S. Cl. 474/28; 474/18

(57) ABSTRACT

In a hydraulic control system of a continuously variable transmission of a vehicle, a switching valve for controlling exhaust pressure of a primary pulley is disposed between an exhaust port of a speed ratio control valve controlling operating pressure of the primary pulley and a line branched from a line supplying line pressure to the speed ratio control valve.

### CROSS-REFERENCE TO RELATED APPLICATION

This application claims priority to and the benefit of Korean Patent Application No. 10-2005-0121385 filed in the Korean Intellectual Property Office on Dec. 10, 2005, the entire contents of which are incorporated herein by reference.

### BACKGROUND OF THE INVENTION

(a) Field of the Invention

The present invention relates to a hydraulic control system of a continuously variable transmission for a vehicle. More particularly, the present invention relates to a hydraulic control system of a continuously variable transmission in which a remaining hydraulic pressure can be maintained in a primary pulley even when the engine is stopped, thus preventing air inflow into the primary pulley.

(b) Description of the Related Art

A continuously variable transmission includes primary and secondary pulleys, one of which is fixed and one of which moves. The moving pulley provides thrust force on a side surface of a metal belt to a degree suitable for driving torque by hydraulic pressure in a hydraulic pressure chamber formed at a rear portion of the moving pulley. Continuous shifting is performed by a change of diameters of the pulleys.

In conventional hydraulic control systems of continuously variable transmissions, although hydraulic pressure is supplied to the primary pulley by control of a speed ratio control valve while the engine operates, but the hydraulic pressure that has been supplied to the primary pulley is completely discharged therefrom when the engine stops, air may flow into the primary pulley.

In addition, if hydraulic pressure that has been supplied to the primary valve is exhausted, hydraulic pressure should be again supplied during engine restarting, and starting of a vehicle may thus be delayed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a hydraulic control system of a continuously variable transmission of a vehicle that retains remaining hydraulic pressure in a primary pulley even when the engine is stopped, thereby preventing air inflow and reducing a time period of resuming power delivery during an engine restart.

In an exemplary hydraulic control system of a continuously variable transmission, a switching valve for controlling exhaust pressure of the primary pulley is disposed between an exhaust port of a speed ratio control valve controlling operating pressure of the primary pulley, and a line branched from a line supplying line pressure to the speed ratio control valve.

The switching valve may include a plunger slidably disposed within a valve body, such that the exhaust pressure of the primary pulley and the line pressure act on a front end of the plunger; and an elastic member supporting the plunger at its rear end.

The front end of the plunger may be conical. A guide rod may have an end contacting the front end of the plunger, and the guide rod may be disposed in a control port branched from a hydraulic pressure line for supplying the line pressure.

An input port through which the exhaust pressure of the primary pulley is supplied may be configured such that the exhaust pressure acts on the front end portion of the plunger.

### BRIEF DESCRIPTION OF THE DRAWINGS

FIG. 1 is a schematic diagram of an exemplary hydraulic control system of a continuously variable transmission;

FIG. 2 shows a main portion of a hydraulic control system of a continuously variable transmission according to an exemplary embodiment of the present invention in a state in which the engine operates; and

FIG. 3 shows the portion of FIG. 2 in a state in which an engine does not operate.

### DETAILED DESCRIPTION OF THE PREFERRED EMBODIMENTS

An exemplary embodiment of the present invention will hereinafter be described in detail with reference to the accompanying drawings.

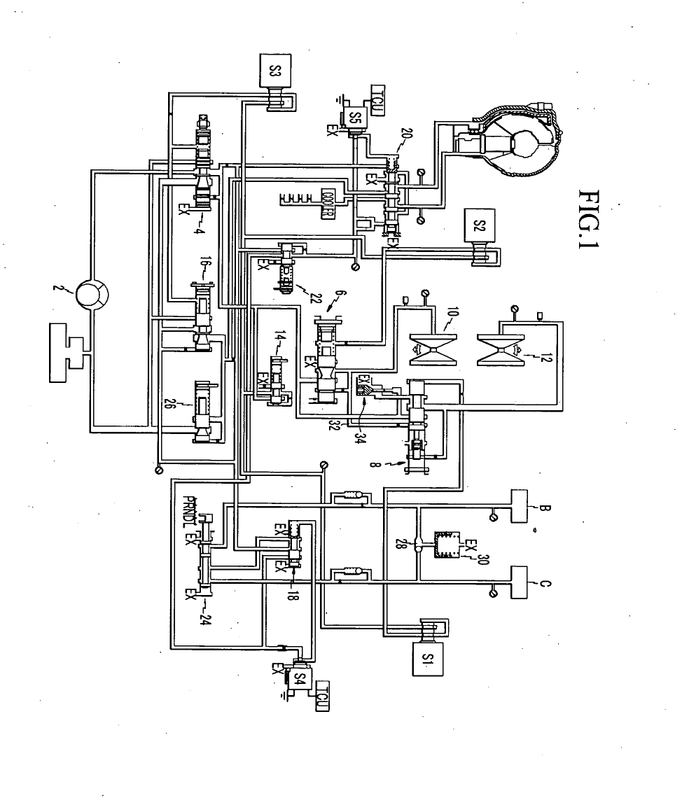

Referring to FIG. 1, in an exemplary hydraulic control system, hydraulic pressure output from a hydraulic pump 2 is firstly regulated by a line regulator valve 4, and the regulated hydraulic pressure is supplied to a secondary pulley 10 and a primary valve 12 via a secondary valve 6 and a speed ratio control valve 8 and is also supplied to a first solenoid valve S1, a second solenoid valve S2, and a third solenoid valve S3 via a solenoid control valve 14.

In addition, a control pressure of the first solenoid valve S1 is supplied as a control pressure of a speed ratio control valve 8 and a control pressure of the second solenoid valve S2 is supplied as a control pressure of the line regulator valve 4 and a second regulator valve 16.

At least a portion of hydraulic pressure of the line regulator valve 4 is supplied to the second regulator valve 14 and is secondly regulated, and the regulated hydraulic pressure is supplied as pressure torque converter supply pressure of a pressure control valve 18 and a damper clutch control valve 20 and is supplied to a reducing valve 22.

The hydraulic pressure supplied to the reducing valve 22 is reduced by the reducing valve 22 and is then supplied as a control pressure of the fourth solenoid valve S4 and the fifth solenoid valve S5. The hydraulic pressure supplied to the pressure control valve 18 is controlled by the fourth solenoid valve S4 and is then supplied to a manual valve 24, the hydraulic pressure supplied to the manual valve 24 is selectively supplied to a forward clutch C or a reverse brake B depending on a range conversion, and the hydraulic pressure supplied to the damper clutch control valve 20 acts as a torque converter supply pressure by a control of the fifth solenoid valve S5.

In addition, a torque converter feed valve 26 communicates with a release line of the damper clutch control valve 20 and controls torque converter release pressure.

The first solenoid valve S1, the second solenoid valve S2, the third solenoid valve S3, and the fourth solenoid valve S4 are a 3-way valve, and the fifth solenoid valve S5 is an on/off valve. A line connecting the manual valve 24 to the forward clutch C and a line connecting the manual valve 24 and the reverse brake B are connected to each other, and a shuttle valve 28 is disposed therebetween. The shuttle valve 28 is connected to an accumulator 30, so that shock-absorbing performance for hydraulic pressure supplied to both friction members is performed by one accumulator 30.

Referring still to FIG. 1, a hydraulic control system according to an exemplary embodiment of the present invention includes a switching valve 34 between an exhaust port of the speed ratio control valve 8 and a hydraulic pressure line 32 for supplying line pressure to a speed ratio control valve 8 from a line regulator valve 4, such that exhaust pressure exhausted from the primary pulley 12 is controlled.

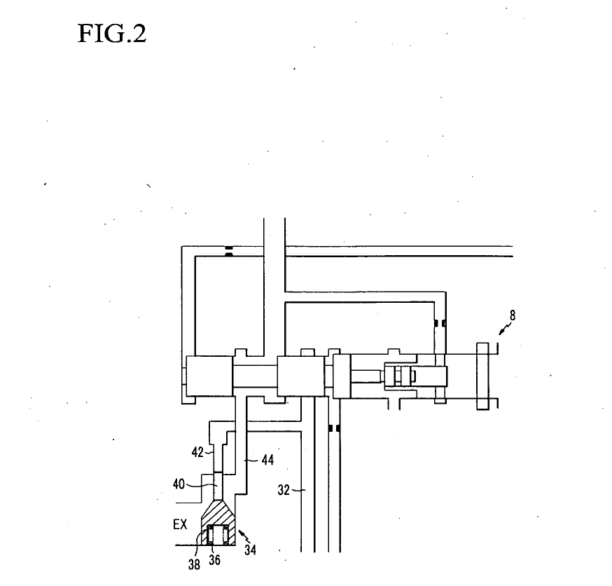

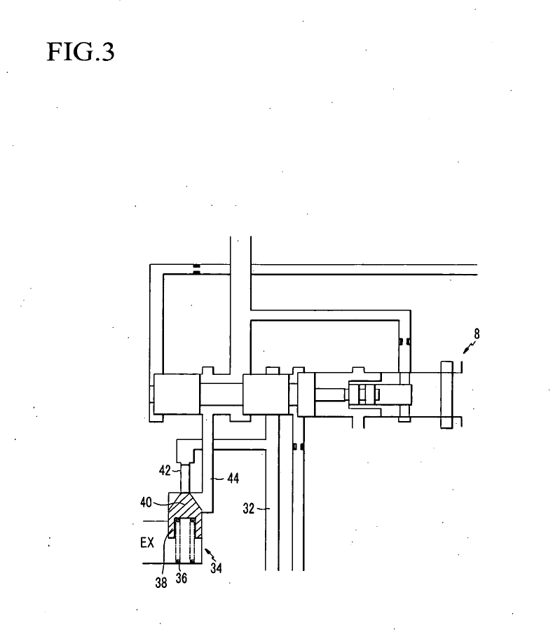

As shown in FIG. 2 and FIG. 3, the switching valve 34 includes a plunger 38 slidably disposed within a valve body, and an elastic member 36 supporting the plunger 38 at a rear side of the plunger 38.

A front end of the plunger 38 (the top end in FIGS. 2 and 3) is conical, and a guide rod 40 contacts the front end of the plunger 38. The guide rod 40 is disposed in a control port 42 branched from the hydraulic pressure line 32 supplying line pressure, and thereby the line pressure may act on the plunger 38.

In addition, an exhaust pressure input port 44 is connected to the speed ratio control valve 34 neighboring the control port 42, so that the exhaust pressure can act on the front end of the plunger 38.

Accordingly, while an engine operates, a portion of the line pressure supplied to the speed ratio control valve 8 is supplied to the control port 42, so that the plunger 38 is maintained in the retracted state shown in FIG. 2 by the line pressure.

In this state, operating pressure is supplied to the primary pulley 12 by control of the speed ratio control valve 8.

If the engine stops in the above-mentioned state, a hydraulic pump 2 stops operating, so that a line pressure supply is cut off. Therefore, as shown in FIG. 3, the plunger 38 of the switching valve 34 moves forward (upward in the drawing) by elastic force of the elastic member 36, thereby closing the exhaust pressure input port 44.

Accordingly, exhausting of operating pressure supplied to the primary pulley 12 is limited, so that the remaining hydraulic pressure may be maintained in the primary pulley 12.

If force due to the hydraulic pressure supplied to the primary pulley 12 is greater than an elastic force of the elastic member 36, the plunger 38 is retracted and at least a portion of the hydraulic pressure in the primary pulley 12 is exhausted. Then, if force due to the hydraulic pressure supplied to the primary pulley 12 is smaller than an elastic force of the elastic member 36, the plunger 38 is positioned as shown in FIG. 3, and exhausting of the hydraulic pressure no longer occurs.

As stated above, according to the present invention, since the hydraulic pressure is maintained even when the engine does not operate by disposing the switching valve between the hydraulic pressure exhaust line of the speed ratio control valve and the line pressure supply line, air inflow can be prevented and a time period until power delivery during engine restarting is resumed can be substantially reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A hydraulic control system of a continuously variable transmission, the transmission comprising primary and secondary pulleys, the system comprising:
a switching valve for controlling exhaust pressure of the primary pulley and disposed between an exhaust port of a speed ratio control valve controlling operating pressure of the primary pulley, and a line branched from a line supplying line pressure to the speed ratio control valve.

2. The hydraulic control system of claim 1, wherein the switching valve comprises:
a plunger slidably disposed within a valve body such that exhaust pressure of the primary pulley and the line pressure act on a first end of the plunger; and
an elastic member supporting the plunger at a second end.

3. The hydraulic control system of claim 2, wherein the first end of the plunger comprises a substantially conical shape, the system further comprising:
a guide rod disposed at least substantially in a control port branched from a hydraulic pressure line for supplying the line pressure and comprising an end contacting the first end of the plunger.

4. The hydraulic control system of claim 1, further comprising an input port through which exhaust pressure of the primary pulley is supplied, configured such that the exhaust pressure acts on the first end of the plunger.

5. The hydraulic control system of claim 1,
wherein the switching valve comprises:
a plunger, comprising a substantially conical first end, and slidably disposed within a valve body such that exhaust pressure of the primary pulley and the line pressure act on the first end of the plunger; and
an elastic member supporting the plunger at a second end;
the system further comprising:
a guide rod disposed at least substantially in a control port branched from a hydraulic pressure line for supplying the line pressure and comprising an end contacting the first end of the plunger; and
an input port through which exhaust pressure of the primary pulley is supplied, configured such that the exhaust pressure acts on the first end of the plunger.

6. A switching valve for a hydraulic control system of a continuously variable transmission, comprising:
a plunger slidably disposed within a valve body such that exhaust pressure of a primary pulley and line pressure act on a first end of the plunger; and
an elastic member supporting the plunger at a second end.

7. The switching valve of claim 6, wherein the first end of the plunger comprises a substantially conical shape, the valve further comprising:
a guide rod disposed at least substantially in a control port branched from a hydraulic pressure line for supplying the line pressure and comprising an end contacting the first end of the plunger.

8. The switching valve of claim 6, wherein an input port through which exhaust pressure of the primary pulley is supplied is configured such that the exhaust pressure acts on the first end of the plunger.
